(19) United States
(12) Patent Application Publication
(10) Pub. No.: US 2020/0133302 A1
(43) Pub. Date: Apr. 30, 2020

(54) METHOD FOR OPERATING AN AUTOMATICALLY MOVING ROBOT

(71) Applicant: Vorwerk & Co. Interholding GmbH, Wuppertal (DE)

(72) Inventor: Lorenz HILLEN, Wuppertal (DE)

(73) Assignee: Vorwerk & Co. Interholding GmbH, Wuppertal (DE)

(21) Appl. No.: 16/347,244

(22) PCT Filed: Nov. 2, 2017
(86) PCT No.: PCT/EP2017/078056

§ 371 Date: May 16, 2019

(30) Foreign Application Priority Data
Nov. 8, 2016 (DE) 10 2016 121 320.9

(51) Int. Cl. G05D 1/02; G01C 21/20

(52) U.S. Cl. CPC G05D 1/0274; G05D 1/0212; B25J 11/0085; G01C 21/206; G05D 1/0282

(57) ABSTRACT

A method for operating an automatically moving robot, wherein a map of the surroundings of the robot is generated using measurement data captured within the surroundings, and a control command is generated using the generated map, the current position of the robot within the surroundings, and a determined behavior of the robot. The robot is moved using the generated control command, and data which is relevant to the navigation of the robot is at least partly transmitted to an external computing device for processing. In order to reduce the computing capacity and/or storage capacity required within the robot, the external computing device determines a desired behavior of the robot as the basis for the control command based on the map and the current position of the robot.

### FIELD OF TECHNOLOGY

The invention relates to a method for operating an automatically moving robot, wherein a map of an environment of the robot is generated based on measurement data recorded within the environment, wherein a control command is generated using the generated map, a current position of the robot within the environment and a determined behavior of the robot, wherein the robot moves using the generated control command, and wherein data relevant for navigating the robot are at least partially transmitted to an external computing device for processing.

The invention further relates to a system comprising an automatically moving robot, an external computing device communicatively linked with the robot, and at least one sensor for recording measurement data within an environment of the robot, wherein the robot has a device for navigating the robot within the environment, wherein the external computing device is set up to process data relevant for navigating the robot.

### PRIOR ART

Methods for mapping and self-localizing robots are known in prior art.

Publications DE 10 2011 000 536 A1 and DE 10 2008 014 912 A1 show such methods, for example in conjunction with automatically movable vacuuming and/or cleaning robots for cleaning floors. In addition, however, these methods can also find application in automatically movable transport robots, lawnmower robots or the like. Such robots are preferably equipped with distance sensors, for example so as to in this way avoid a collision with an obstacle standing in a traversing path or the like. The sensors preferably operate without contact, for example with the assistance of light and/or ultrasound. It is further known to provide the robots with means for all-round distance measurement, for example in the form of an optical triangulation system, which is arranged on a platform rotating around a vertical axis or the like. Systems like these can be used to perform all-round distance measurements for orienting the robot, for example within a room, further in particular during an automatically performed activity of the robot, as well as further preferably for creating a map of the traversed room.

The acquired measurement values, in particular room boundaries and/or obstacles, are processed into a map by an onboard computer of the robot, and in particular stored in a nonvolatile memory of the robot, so that this map can be accessed during a cleaning or transport operation for orientation purposes. Further known in this regard is to use the map and stored algorithms to determine a favorable behavior, in particular traversing strategy, of the robot, for example upon detection of an object lying in the traveling path of the robot.

Additionally known in prior art is to generate the map not in a memory of the robot, but rather in an external computing device, which is communicatively linked with the robot. For example, publication EP 2 769 809 A1 discloses a method for operating a mobile robot, in which a sensor transmits sensor data to a cloud, which then processes the latter into a map. The generated map is then transmitted back to the mobile robot and used by the latter for navigating the robot within the environment.

### SUMMARY OF THE INVENTION

Proceeding from the aforementioned prior art, the object of the invention is to further develop an aforementioned method in such a way as to further relieve the onboard computer of the robot, specifically with respect to computing capacity, storage capacity and/or power consumption.

In order to achieve the aforementioned object, the invention initially proposes a method for operating an automatically moving robot, in which the external computing device determines a desired behavior of the robot as the basis for the control command based upon the map and the current position of the robot.

The invention thus outsources an especially computing-intensive component of robot navigation, specifically the determination of a desired behavior of the robot based upon the generated map, to an external computing device, so as to relieve the onboard computer of the robot. The determination of a desired behavior relates to an advantageous behavior while navigating the robot within the environment, in particular to planning and behavior decisions, for example that influence a traveling strategy of the robot. While determining the behavior of the robot, the external computing device manages a status of the robot, for example the status “cleaning”, “inactive” or the like. This management takes place by means of a behavior determining device, which in addition to managing the status also reacts to environmental influences, for example obstacles within the environment and/or user inputs. Based on these parameters, the behavior determining device determines when the status and/or a behavior currently exhibited by the robot must be changed, for example cleaning must be ended, the robot must approach a base station, an obstacle must be evaded, and the like. Furthermore, the behavior determining device determines actions planned in advance as a desired behavior of the robot, which state where and in what alignment cleaning is to take place, how an environment can be covered completely with a traveling path and the like. The behavior determining device here typically makes use of known behavior architectures and traveling/handling algorithms.

The computing activity of the behavior determining device is here integrated into a process sequence, for example which involves in particular sensor data preparation, mapping, traveling command generation and, if necessary, map preparation. The behavior is here preferably determined after the procedural step of mapping, and takes place at a time before generating a control command.

In particular, the method for mapping and navigation initially involves recording measurement data within the environment of the robot. The measurement data are then fused into a map of the environment of the robot. As a rule, this is an optimization or estimation process, which determines the most probable map for the measured measurement data, specifically up-to-date, newly recorded and already known measurement data. The current position as well as earlier positions of the robot can be derived from this map. Odometry data and distance measurement data are usually fused to put together the map and estimate the position. Such methods belong to the class of so-called SLAM algorithms (simultaneous localization and mapping). Measurement data currently not required for putting together the map, for example additional measurement data of a contact sensor or the like, can be noted in the map using a stored time stamp, so that the present measurement data can be accessed if required during subsequent calculations.

Building upon the created map, planning and decision algorithms are subsequently used to determine a desired behavior of the robot. The determined behavior then in turn serves as the basis for generating a control command, for example for actuating a motor of the robot. For example, if a desired behavior of the robot has been determined that now provides for an obstacle avoidance instead of cleaning, for example, a control command must be generated that changes a straight-ahead line travel of the robot into a curved progression. For example, for robots with a differential drive, this means that the control command now no longer actuates the drive motors with the same speed, but rather with a varying speed, so that the robot negotiates a curve.

Finally, the generated map can also be set up as a display for a user, thereby ensuring that the user can easily find their way in the map, and quickly recognize their living space or parts of rooms and/or areas therein. The originally generated map can here be adjusted via suitable filtering, for example detection of straight segments, elimination of outliers, non-maximum suppression and the like.

According to the invention, not all calculations to be performed for navigation are carried out on the onboard computer, as opposed to the classic, autonomous mobile robots. This relates in particular to the computing-intensive determination of a desired behavior of the robot based on the generated map. The determination results are instead made available to the robot by the external computing device, wherein the robot can thereupon perform its working activity in the usual manner. Outsourcing computations to the external computing device yields advantages with respect to the utilization of the computing power and memory of the onboard computer of the robot. In addition, the navigation software is advantageously centralized. In classic, autonomous mobile robots, each robot is equipped with a copy of the navigation software. Even if robots are usually updatable, it does take some time for a user to notice the update and install it. In addition, it must be assumed that not all users even install an update, so that a very heterogeneous distribution of software versions on the used robots exists after a prolonged period, making it difficult for the manufacturer of the robot to service the respective robot. The invention can now be used to also execute essential parts of the navigation software centrally in the external computing device, so that all robots always work with navigation software having the same version status. As soon as a software update is available, the previous software version is automatically replaced without the user having to make arrangements for this. Centralizing the navigation software in the external computing device also makes it possible to modify the hardware on which the software was installed after delivery of the robot, for example so that software features can be subsequently activated that could not have been executed with the originally selected hardware.

In the proposed method, the robot can now be equipped with a relatively low-power onboard computer, for example a microcontroller for sensor data evaluation and motor actuation, which is uniformly utilized during a movement of the robot. For the calculations outsourced to the external computing device, the robot shares the computing power and storage capacity made available by the external computing device with other robots that are also currently active. Within the framework of the resources available on the external computing device, each robot can here request the resources that it requires, for example as a function of a current work task or an environment within which it navigates. The resources of the external computing device available for all robots can be adjusted to peak times when very many or very few robots are active. This results in a uniform utilization of the used resources in relation to computing power and memory. In addition, it can be provided that several robots on the external computing device also exchange information with each other, for example such that a first robot can access a map or navigation data of a second robot.

In addition, it is proposed that the external computing device generate the map of the environment. In this embodiment, not only is the behavior of the robot determined in the external computing device, so too is the preceding step of map generation. As a consequence, the local computing and memory capacity required on the robot can be further reduced. However, it is alternatively possible as before that the map be generated by the onboard computer of the robot and then transmitted to the external computing device.

In addition, it can be provided that the robot record measurement data of the environment with at least one sensor and transmit these measurement data to the external computing device for generating the map. The robot thus has one or several sensors, which measure the environment of the robot and then make the recorded measurement data available to the external computing device for generating the map. Alternatively, it would also be possible for the sensors to not be locally assigned to the robot, but rather represent external sensors, for example which are immovably arranged within the environment. For example, this can be a camera, which is arranged on the wall of a room, and records images of the environment with the robot located therein. The sensor need here also not be immovably arranged within the room, but can rather move within the room, enabling a measurement from various perspectives, as would also be enabled if the sensor were to be arranged on the robot itself. In a preferred embodiment where the sensor is immovably connected with the robot, the measurement data can preferably be recorded via odometry, distance measurement, in particular laser range finding, contact measurement, and/or by means of drop sensors and/or magnetic sensors, and/or a status of a drive unit of the robot can be evaluated. Also conceivable beyond that are other sensors of the robot, for example temperature sensors, moisture sensors, air quality sensors, cameras, smoke detectors and the like, which can potentially provide an indication about a current position within an environment. Apart from this physical recording of measurement data, measurement data can also be recorded by combining specific features, measured values or states of physical sensors. For example, measured data are here recorded by means of so-called virtual sensors, which are provided by the software. One example for the latter is a slip sensor, which combines odometry and distance measurement data in such a way as to yield specific and/or links, which either point to a slip or not. For example, if the driving wheels of the robot are turning without the robot moving, it can be inferred that there is slippage at the current position of the robot.

In addition, it is proposed that measurement data of the environment be transmitted to the external computing device, and that the external computing device check the transmitted measurement data for completeness and/or plausibility and/or convert them into a format suitable for generating the map. For example, this ensures that the measurement data of all available sensors are read out and/or contain no errors. In addition, for example, the analog-digital conversions and/or value range adjustments can take place. Furthermore, the measurement data can be provided with time stamps, so that the latter are available later while generating the map. Parts of this sensor data preparation can here also be performed on the onboard computer of the robot.

It is also proposed that the navigation-relevant data be processed on a cloud server and/or a mobile communication device and/or a device connected with the robot via a WLAN and/or a WLAN router as the external computing device. Apart from cloud servers, then, a mobile device, e.g., a mobile phone, a laptop, a tablet computer or the like, can be used to determine the behavior of the robot and possibly also to generate the map and/or prepare sensor data. A user of the robot can here also perform a user input on this mobile device. As a consequence, a plurality of functions is assigned to the mobile device. In addition, the calculations can also be performed on a device connected with the robot via a WLAN. For example, such a device can likewise be a robot that is currently not being used for a working activity, a PC integrated into the WLAN, some other household appliance or the like. A WLAN router or smart home server can also serve to perform the calculation if the navigation software can be implemented on these devices, for example in the form of a plugin. Wireless data transmission methods, for example WLAN, Bluetooth, NFC, ZigBee, mobile radio and the like, can be used for transmitting the data from the robot to the external computing device and from the external computing device to the robot, or for transmitting the data from sensors to the external computing device. The transmitted data can also be transmitted via a cloud server, which functions to relay messages, but not perform calculations.

The method can further provide that the external computing device transmit information about the determined behavior to the robot, and that the robot generate a control command based on the determined behavior. According to this embodiment, control commands are thus generated within the robot, i.e., by means of the onboard computer of the robot.

An alternative embodiment can provide that the external computing device use the determined behavior to generate a control command and transmit the latter to the robot. The external computing device is here used both to calculate the determined behavior and generate the control command, wherein the generated control command is then transmitted to the robot and available directly for controlling a drive unit of the robot, for example, without additional calculations having to take place within the robot.

Finally, it is proposed that a user of the robot initiate an input for the external computing device by means of an input device communicatively linked with the external computing device, in particular by means of a mobile communication device. The input device can here be a mobile telephone, a tablet computer, a laptop or the like, or among other things a user interface of the robot itself. In addition, an input device can be provided on the external computing device itself, in particular immovably, in particular if the external computing device itself is a mobile communication device, a PC or the like, which thus serves as an external computing device on the one hand, and as an input device on the other. Even if a robot basically makes do without an input device, it still usually has a module for user interaction. Such a module is responsible for receiving user inputs and, for example, relaying them to a behavior determining device or outputting feedback or status information from the behavior determining device to a user of the robot. This type of input device can be configured in various ways, for example in the form of a display, a button, a receiving unit for receiving and processing commands from a remote control unit, for example through infrared transmission, in the form of an app implemented on the robot and/or on the robot and an additional communication interface of an external computing device, and the like.

Apart from the method described above for operating an automatically moving robot, the invention also proposes a system comprised of an automatically moving robot, an external computing device communicatively linked with the robot, and at least one sensor for recording measurement data within an environment of the robot, wherein the robot has a device for navigating the robot within the environment, wherein the external computing device is set up to process data relevant for navigating the robot, wherein the external computing device has a behavior determining device set up to use a generated map of the environment and a current position of the robot to determine a desired behavior of the robot as the basis for a control command for controlling the robot.

According to the invention, the external computing device now has a behavior determining device for determining a behavior of the robot, wherein this behavior in turn serves as the basis for generating the control command. The desired behavior is determined by means of the behavior determining device based upon the generated map and current position of the robot. Otherwise, the robot and/or external computing device can also be configured in such a way as to be suitable for implementing a method according to one of the preceding claims. This relates in particular to the allocation of devices for sensor data preparation, map generation, map preparation and/or for user input on the robot or external computing device.

According to the invention, an automatically moving robot basically refers to any type of robot that can independently orient itself and move within an environment and perform work activities in the process. Intended here in particular, however, are cleaning robots, for example which perform a vacuuming and/or mopping task, mow a lawn, monitor the status of an environment, for example in the form of a smoke detector and/or burglar alarm or the like.

### BRIEF DESCRIPTION OF THE DRAWINGS

The invention will be explained in greater detail below based on exemplary embodiments. Shown on:

FIG. 1 is a perspective view of a robot from outside,

FIG. 2 is a robot communicatively linked with an external computing device, during a run within an environment,

FIG. 3 is a system comprised of a robot and an external computing device according to a first embodiment,

FIG. 4 is a system comprised of a robot and an external computing device according to a second embodiment,

FIG. 5 is a system comprised of a robot and an external computing device according to a third embodiment.

### DESCRIPTION OF THE EMBODIMENTS

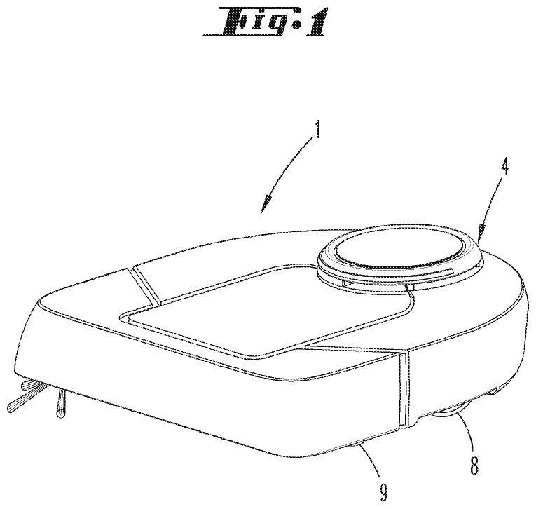

FIG. 1 shows a robot 1, which here is designed as an automatically moving vacuuming robot. The robot 1 has a housing, the bottom side of which facing a surface to be cleaned has arranged on it electric motor-driven wheels 8 as well as an also electric motor-driven brush 9 that protrudes over the lower edge of the housing floor. In the area of the brush 9, the robot 1 further has a suction mouth opening (not shown in any more detail), through which a motor-blower unit can aspirate air loaded with suction material into the robot 1. The robot 1 has a rechargeable accumulator (not shown) for supplying power to the individual electrical components of the robot 1, as well as for driving the wheels 8 and brush 9 and other additionally provided electronics.

The robot 1 is further equipped with a sensor 4, which is arranged within the housing of the robot 1. For example, the sensor 4 is here part of a triangulation device, which can measure distances to obstacles 7 within an environment of the robot 1. Specifically, the sensor 4 has a laser diode, whose emitted light beam is guided out of the housing of the robot 1 via a deflecting device and can be rotated around a rotational axis that is perpendicular in the depicted orientation of the robot 1, in particular at a measuring angle of 360 degrees. This enables an all-round distance measurement.

The sensor 4 can be used to measure an environment of the robot 1 in a preferably horizontal plane, i.e., in a plane parallel to the surface to be cleaned. As a result, the robot 1 can be moved while avoiding a collision with obstacles 7 in the environment. The measurement data recorded by the sensor 4, which represent distances to obstacles 7 and/or walls in the environment, are used for generating a map 2 of the environment.

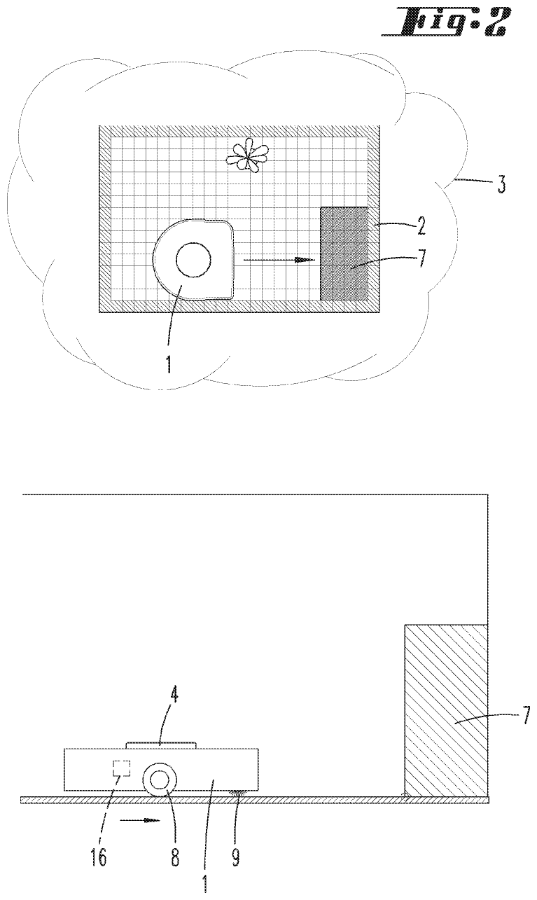

FIG. 2 shows the robot 1 in an environment with an obstacle 7, which is here arranged in front of the robot 1 in the traveling direction of the robot 1. The robot 1 is communicatively linked with an external computing device 3, which is here a cloud server. Alternatively, however, this external computing device 3 could also be a mobile communication device, for example, in particular a mobile telephone or the like. A memory of the external computing device 3 has the map 2 of the environment of the robot 1. Both the position of the obstacle 7 and the current position and orientation of the robot are recorded in this map 2. This map 2 can be generated using either an onboard computing device 16 of the robot 1 or the external computing device 3.

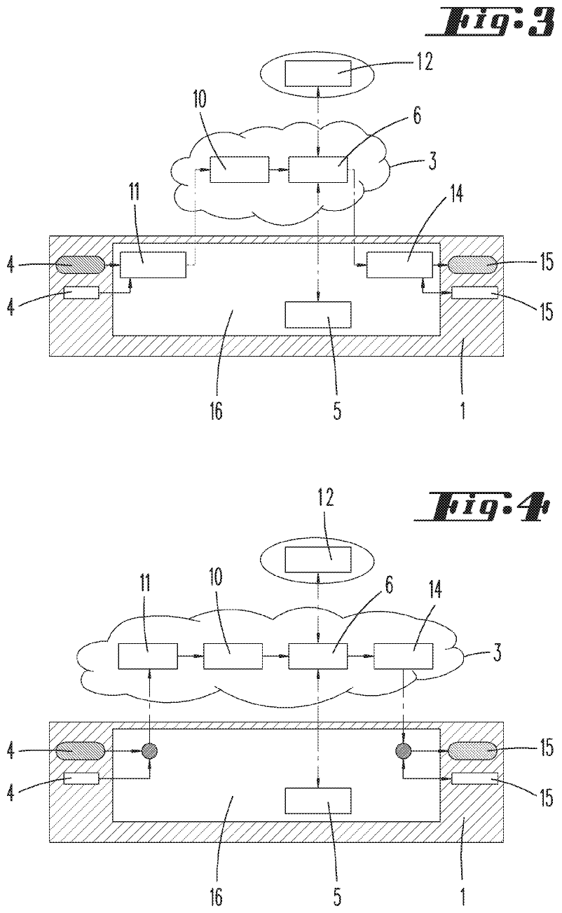

Several computing steps are basically necessary for navigating the robot 1 within the environment, and hence also for avoiding obstacles 7. On the one hand, the map 2 must first be generated from the measurement data of the sensor 4, and possibly also the measurement data of additional sensors 4, for example those of an odometry sensor and/or contact sensor, which takes place either within the robot 1 or within the external computing device 3. Based on the map 2 and thus a likewise known current position of the robot 1 within the environment, a behavior of the robot 1 which serves as the basis for a control command is then computed by means of a behavior determining device 6 of the external computing device 3, as has yet to be described in greater detail below with reference to FIGS. 3 to 5. For example, such a desired behavior of the robot 1 here involves ending a straight-line travel of the robot 1, which would lead directly to the obstacle 7, and initiating an avoidance of the obstacle 7 through a cornering maneuver. The calculated behavior serving to avoid the obstacle 7 is then transmitted to a command device 14, which generates a control command suitable for navigating the robot 1 by the obstacle 7. This command device 14 can be allocated either to the external computing device 3 or the robot 1. For example, the control command output by the command device 4 then serves to actuate a motor 15 of a drive device of the wheels 8 in such a way that the robot 1 passes by the obstacle 2 to the left relative to the illustration on FIG. 2.

According to the invention, a plurality of different embodiments of the robot 1 and external computing device 3 along with varying procedures for the latter are now conceivable. FIGS. 3 to 5 exemplarily show several of the possible variants, wherein the depicted illustrations are in no way to be construed as final; rather, additional combinations or subtypes are possible.

The first embodiment shown on FIG. 3 contains a robot 1, which among other things has several sensors 4 and several motors 15 for driving the wheels 8. The robot 1 further comprises an onboard computing device 16, which specifically has a sensor data preparation device 11, a command device 14 and a user interface 5. For example, the user interface 5 is here a touchscreen, which displays a status of the robot 1 to the user and provides the option of interacting via an input function. The external computing device 3 has a mapping device 10 and a behavior determining device 6. The behavior determining device 6 has a communication link to a user interface 12, which here is made available by another external device, for example by a mobile communication device, such as a mobile telephone. The user can directly influence the behavior of the robot 1 by way of this user interface 12, for example by initiating a change in the status of the robot 1 from “inactive” to “cleaning a surface”.

According to this embodiment, the method for operating the robot 1 functions in such a way that the sensors 4 of the robot 1 continuously record measurement data within the environment during a cleaning run of the robot 1. As described above, these measurement data preferably have distance values to obstacles 7 as well as odometry data. The sensors 4 transmit the measurement data to the sensor data preparation device 11 of the robot 1, which subjects the measurement data to a completeness check, conversion from analog to digital data, and scaling. The sensor data preparation device 11 transmits the prepared measurement data to the external computing device 3. For example, communication here takes place via a WLAN network, into which the robot 1 is integrated, and which is communicatively linked to the external computing device 3 via the internet. The mapping device 10 of the external computing device 3 processes the measurement data into a map 2 of the environment, for example using a so-called SLAM method (simultaneous localization and measurement), wherein the generated map 2 simultaneously also contains the current position of the robot 1 in the environment. The behavior determining device 6 of the external computing device 3 accesses the generated map 2, and determines a suitable behavior of the robot 1 serving as the basis for a control command from the map 2, the current position of the robot 1 within the environment, and possibly a user input that a user has transmitted directly to the behavior determining device 6 via the user interface 12. In the aforementioned case, the behavior determining device 6 recognizes that an obstacle 7 is located within the current traveling path of the robot 1, so that a collision with the obstacle 7 will shortly take place. In subsequent computations via suitable planning and decision algorithms, the behavior determining device 6 then determines a suitable behavior of the robot 1. For example, the determined behavior is here “avoid obstacle 7”. The behavior determining device 6 transmits this determined behavior to the command device 14 of the robot 1, which thereupon generates several control commands, which serve to actuate the motors 15 in such a way that the robot 1 can avoid the obstacle 7. As a whole, outsourcing map generation and behavior generation to the external computing device 3 leads to a reduction in the computing and storage capacities of the onboard computing device 16 of the robot 1.

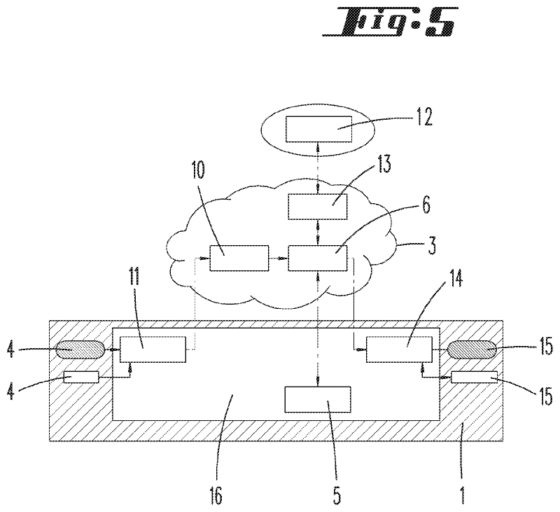

FIG. 4 shows a second embodiment of the invention, in which the onboard computing device 16 of the robot 1 only has just one user interface 5. All devices for processing navigation-relevant data are outsourced to the external computing device 3. Specifically, the external computing device 3 now has a sensor data preparation device 11, a mapping device 10, a behavior determining device 6, and a command device 14. The sensors 4 of the robot 1 now transmit their measurement data directly to the sensor data preparation device 11 of the external computing device 3. The measured data are there prepared as described above and transmitted to the mapping device 10, which thereupon again generates a map 2 of the environment, including a current position of the robot 1. The behavior determining device 6 accesses the map 2 and uses the current traveling situation of the robot 1, i.e., as a function of the position of the robot 1 and obstacles 7 possibly present in the traveling path, to determine a behavior of the robot 1 that here leads to a desired avoidance of the obstacle 7. The determined behavior is transmitted to the command device 14, which likewise is present in the external computing device 3. It generates control commands suitable for avoiding the obstacle 7 and transmits them to the motors 15 of the robot 1, without any further computations being required within the onboard computing device 16 of the robot 1. In this case, the onboard computing device 16 only serves to relay the control commands to the motors 15, which thereupon drive the wheels 8 of the robot 1 in such a way as to yield a collision-free traveling path by the obstacle 7 in the depicted example.

According to this embodiment, the required resources of the robot 1 for calculations and storage capacity are further reduced in relation to the embodiment according to FIG. 3.

Finally, FIG. 5 shows a third embodiment of the invention, in which the robot 1 is designed identically to the first embodiment according to FIG. 3. The onboard computing device 16 of the robot 1 has a sensor data preparation device 11, a user interface 5 and a command device 14. Apart from a mapping device 10 and a behavior determining device 6, the external computing device 3 also has a map preparation device 13, which is communicatively linked with the behavior determining device 6 on the one hand, and the user interface 12 on the other, which is here designed as a mobile telephone. The map preparation device serves to prepare the map generated by the mapping device 10 in such a way as to note a specific behavior determined by the behavior determining device 6 on the one hand, and on the other to prepare a graphic illustration of the map 2 in such a way that a user of the robot 1 can orient themselves within the map 2 without any significant conceptual transfer effect, and additionally recognizes what behavior the robot 1 is currently pursuing. In the case at hand, for example, the map 2 displayed on the user interface 12 can indicate that the robot 1 is currently performing an obstacle avoidance maneuver so as to circumvent the obstacle 7.

Embodiments other than the embodiments shown on the figures are of course also possible, wherein all share in common that the behavior of the robot 1, which serves as the basis for a control command, is computed within the external computing device 3.

### REFERENCE LIST

1 Robot
2 Map
3 External computing device
4 Sensor
5 User interface
6 Behavior determining device
7 Obstacle
8 Wheel
9 Brush
10 Mapping device
11 Sensor data preparation device
12 User interface
13 Map preparation device
14 Command device
15 Motor
16 Onboard computing device

1. A method for operating an automatically moving robot (1), wherein a map (2) of an environment of the robot (1) is generated based on measurement data recorded within the environment, wherein a control command is generated using the generated map (2), a current position of the robot (1) within the environment and a determined behavior of the robot, wherein the robot (1) moves using the generated control command, and wherein data relevant for navigating the robot (1) are at least partially transmitted to an external computing device (3) for processing, wherein the external computing device (3) determines a desired behavior of the robot (1) as the basis for the control command based upon the map (2) and the current position of the robot (1), wherein a behavior determining device (6) decides when a status of the robot (1) and/or a behavior currently shown by the robot (1) must be changed, wherein the external computing device (3) transmits information about the determined behavior to the robot (1), and the robot (1) generates a control command based on the determined behavior.

2. The method according to claim 1, wherein the external computing device (3) generates the map (2) of the environment.

3. The method according to claim 2, wherein the robot (1) records measurement data of the environment with at least one sensor (4), and transmits these measurement data to the external computing device (3) for generating the map (2).

4. The method according to claim 1, wherein measurement data of the environment are transmitted to the external computing device (3), and that the external computing device (3) checks the transmitted measurement data for completeness and/or plausibility and/or converts them into a format suitable for generating the map (2).

5. The method according to claim 1, wherein the measurement data for generating the map (2) are recorded via distance measurement and/or odometer and/or collision detection.

6. The method according to claim 1, wherein the navigation-relevant data are processed on a cloud server and/or a mobile communication device and/or a device connected with the robot via a WLAN and/or a WLAN router as the external computing device (3).

7. (canceled)

8. (canceled)

9. The method according to claim 1, wherein a user of the robot (1) initiates an input for the external computing device (3) by means of an input device (5) communicatively linked with the external computing device (3), in particular by means of a mobile communication device.

10. A system comprised of an automatically moving robot (1), an external computing device (3) communicatively linked with the robot (1), and at least one sensor (4) for recording measurement data within an environment of the robot (1), wherein the robot (1) has a device for navigating the robot (1) within the environment, wherein the external computing device (3) is set up to process data relevant for navigating the robot (1), wherein the external computing device (3) has a behavior determining device (6) set up to use a generated map (2) of the environment and a current position of the robot (1) to determine a desired behavior of the robot (1) as the basis for a control command for controlling the robot (1), wherein the behavior determining device (6) decides when a status of the robot (1) and/or a behavior currently shown by the robot (1) must be changed, and wherein the external computing device (3) is set up to transmit information about the determined behavior to the robot (1), wherein the robot (1) is set up to generate a control command based on the determined behavior.
